(19) United States
(12) Patent Application Publication
(10) Pub. No.: US 2025/0330240 A1
(43) Pub. Date: Oct. 23, 2025

(54) METHOD AND APPARATUS FOR LINK DISCOVERY IN OPTICAL CROSS-CONNECTIONS

(71) Applicant: HUAWEI TECHNOLOGIES CO., LTD., SHENZHEN (CN)

(72) Inventors: Zhiping JIANG, Kanata (CA); Hao LI, Kanata (CA)

(73) Assignee: HUAWEI TECHNOLOGIES CO., LTD., SHENZHEN (CN)

(21) Appl. No.: 18/638,263

(22) Filed: Apr. 17, 2024

(51) Int. Cl. H04B 10/079; H04L 41/12; H04Q 11/00

(52) U.S. Cl. CPC H04B 10/07955; H04L 41/12; H04Q 11/0062; H04Q 2011/0083

(57) ABSTRACT

Methods and apparatus for link discovery at optical cross-connects are disclosed. To determine which connections should be made between communication channels at a node of an optical network, embodiments of the present disclosure are generally directed towards detecting connection information encoded in optical signals received from the communication channels. Embodiments detect the connection information by tapping each communication channel, directing samples of the optical signals from the channels to a same sensor unit, and decoding a spatiotemporal power distribution detected by the sensor unit. In some embodiments, each communication channel substantially corresponds to a respective spatial portion of the spatiotemporal power distribution, and the communication information of each communication channel is encoded temporally, such as by a power dither. In some embodiments, the sensor unit is a photodetector array comprising a plurality of pixels.

### CROSS-REFERENCE TO RELATED APPLICATIONS

This is the first application filed for the present invention.

### FIELD OF THE INVENTION

The present invention pertains to optical communications and, in particular, to methods and apparatus for optical cross-connections.

### BACKGROUND

To enable communication between multiple users of a network, all the users need to be connected. Fiber-optic channels can provide point-to-point connections in a network and are typically interconnected through central switches. Historically, these switches have been electronic switches that convert the optical signals received from a transmitting fiber-optic channel to electrical signals and then convert the electrical signals back to optical signals for the receiving fiber-optic channel. However, optical cross-connects (OXCs) have been introduced as all-optical switches that can optically connect one fiber-optic channel to another. OXCs typically include two arrays of microelectromechanical systems (i.e., MEMS) mirrors that direct the light from one port of the OXC to any other. By avoiding electrical-to-optical and optical-to-electrical conversions, OXCs can reduce costs, power consumption, and latency in comparison to electrical switches.

OXCs, however, are transparent for the optical signals and are therefore incapable of detecting, from the signals, information on which connection should be made. Power dithers, or amplitude modulation pilot tones (AM-PTs or simply PTs), have been added to the signals to indicate channel information, which can be detected by tapping a portion of the light input to the OXC and measuring the power with a photodetector. In this way, the correct link can be discovered. However, in these methods, either each input channel needs a photodetector, which is typically costly, or multiple channels must share one photodetector, which requires channel replacements to be done in groups or sequentially.

Therefore, there is a need for a method and apparatus for OXC link discovery that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for OXC link discovery.

A first aspect of the present disclosure is to provide a method for managing optical connections in a network. The method may be performed at a node of the network, the node having a first set of ports and a second set of ports. The method may comprise receiving, at each port of the first set of ports, a respective optical signal encoded with respective connection information defined by a respective temporal power variation of the respective optical signal. The respective connection information, for each optical signal, may identify which port of the second set of ports is to be connected to the respective port of the first set of ports. The method may further comprise tapping each optical signal to obtain a respective signal sample having the respective power variation of the respective optical signal and imaging, by a same sensor unit, the signal samples to obtain a spatiotemporal power distribution depending from the respective temporal power variation of each optical signal. Each of the signal samples may provide a respective spatial contribution to the spatiotemporal power distribution. The method may further comprise decoding the spatiotemporal power distribution to obtain the respective connection information encoded in each optical signal and configuring one or more optical connections to couple each port of the first set of ports to a respective port of the second set of ports in accordance with the respective connection information.

In some embodiments of the first aspect, decoding the spatiotemporal power distribution to obtain the respective connection information encoded in each optical signal may include: partitioning, in accordance with the spatiotemporal power distribution, the same sensor unit into a plurality of sub-sensors each corresponding to one port of the first set of ports; and integrating, for each sub-sensor of the plurality of sub-sensors, a respective portion of the spatiotemporal power distribution to obtain a respective power sum. In some of these embodiments, decoding the spatiotemporal power distribution to obtain the respective connection information encoded in each optical signal may further include monitoring, for each sub-sensor of the plurality of sub-sensors, the respective power sum for a pre-determined duration. In some of these embodiments, the pre-determined duration may correspond to a data frame of each optical signal.

In some embodiments of the first aspect, for each optical signal, the respective temporal power variation may be a respective amplitude modulation pilot tone.

In some embodiments of the first aspect, the same sensor unit may be a two-dimensional array of photodetector pixels.

In some embodiments of the first aspect, configuring the one or more optical connections to couple each port of the first set of ports to the respective port of the second set of ports in accordance with the respective connection information may include configuring a plurality of mirror arrays, each mirror array including a plurality of microelectromechanical mirrors. In some of these embodiments, for one mirror array of the plurality of mirror arrays, each microelectromechanical mirror may correspond to a respective port of the first set of ports, and for one other mirror array of the plurality of mirror arrays, each microelectromechanical mirror may correspond to a respective port of the second set of ports.

In some embodiments of the first aspect, the method may further comprise directing each signal sample to the same sensor unit by one or more optical components.

A second aspect of the present disclosure is to provide a network switch comprising a plurality of ports, a sensor unit, and a processor unit. The plurality of ports may each be configured to receive a respective optical signal where each optical signal is encoded with respective connection information defined by a respective temporal power variation of the respective optical signal. The respective connection information, for each optical signal, may identify a respective other port of the plurality of ports to be connected to the port receiving the respective optical signal. Each port may have a respective tap configured to obtain a respective signal sample from the respective optical signal, with each signal sample having the temporal power variation of the respective optical signal. The sensor unit may be configured to image the signal samples to obtain a spatiotemporal power distribution depending from the respective temporal power variation of each optical signal, with each of the signal samples providing a respective spatial contribution to the spatiotemporal power distribution. The processor unit may be configured to decode the spatiotemporal power distribution to obtain, for each port, the respective connection information encoded in each optical signal.

In some embodiments of the second aspect, the network switch may further comprise a linker component that may be configured to connect each port of the plurality of ports with every other port of the plurality of ports. In some of these embodiments, the processor unit may be further configured to direct the linker component to connect each of one or more ports of the plurality of ports to the respective other port of the plurality of ports in accordance with the respective connection information encoded in the respective optical signal. In some of these embodiments, the linker component may include a plurality of microelectromechanical mirrors each corresponding to a respective port of the plurality of ports. In some embodiments, the network switch may further comprise a plurality of mirror arrays each configured connect a respective set of ports from among the plurality of ports to another set of ports from among the plurality of ports, with each mirror array including a plurality of microelectromechanical mirrors.

In some embodiments of the second aspect, the processor unit being configured to decode the spatiotemporal power distribution to obtain, for each port, the respective connection information encoded in each optical signal may include being configured to: partition, in accordance with the spatiotemporal power distribution, the sensor unit into a plurality of sub-sensors each corresponding to one port of the plurality of ports; and integrate, for each sub-sensor of the plurality of sub-sensors, a respective portion of the spatiotemporal power distribution to obtain a respective power sum. In some of these embodiments, the processor unit being configured to decode the spatiotemporal power distribution to obtain, for each port, the respective connection information encoded in each optical signal may further include being configured to monitor, for each sub-sensor of the plurality of sub-sensors, the respective power sum for a pre-determined duration. In some of these embodiments, the pre-determined duration may correspond to a data frame of each optical signal.

In some embodiments of the second aspect, the network switch may further comprise one or more optical components configured to direct each signal sample to the sensor unit.

In some embodiments of the second aspect, the sensor unit may be a two-dimensional array of photodetector pixels.

In some embodiments of the second aspect, for each optical signal, the respective temporal power variation may be a respective amplitude modulation pilot tone.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a schematic for an OXC, according to an example typical of the prior art.

FIG. 2A shows a perspective-view of a MEMS mirror, according to an example typical of the prior art.

FIG. 2B shows a perspective-view of a MEMS mirror array, according to an example typical of the prior art.

FIG. 3 shows a schematic for reconfiguring optical connections at an OXC, according to an example typical of the prior art.

FIG. 4A shows a graph of power versus time for an optical signal with a power dither, according to an example typical of the prior art.

FIG. 4B shows a schematic for tapping an optical signal at an OXC, according to an example typical of the prior art.

FIG. 5 shows a schematic for encoding connection information in a data frame, according to an example typical of the prior art.

FIG. 6 shows a schematic for reconfiguring optical connections at an OXC, according to an embodiment of the present disclosure.

FIG. 7A shows a schematic for a sensor unit for link discovery at an OXC, according to an embodiment of the present disclosure.

FIG. 7B shows a schematic for partitioning a sensor unit into virtual detectors for link discovery at an OXC, according to an embodiment of the present disclosure.

FIG. 8 shows a flowchart of a method for link discovery at an OXC, according to an embodiment of the present disclosure.

FIG. 9 shows a schematic of an apparatus for link discovery, according to embodiments of the present disclosure.

FIG. 10 shows a schematic of an embodiment of an electronic device that may implement at least part of the methods and features of the present disclosure.

It will be noted that throughout the appended drawings, like features are identified by like reference numerals.

### DETAILED DESCRIPTION

To enable link discovery in OXCs, embodiments of the present disclosure are generally directed towards providing methods and apparatus for tapping incoming optical signals and directing the tapped signals to a same sensor unit to extract a spatiotemporal power distribution that encodes connection information for the incoming signals. Each optical signal may be received from a respective network device at a respective port of the OXC. Each signal may further have a temporal power variation, such as a power dither or power tone, that encodes the connection information for the respective network device. The spatial arrangement of tapped signals detected by the same sensor unit, such as a photodetector array, may be used to differentiate the temporal power variations of each signal. OXC ports may be connected in accordance with the decoded connection information to correctly provide links between network devices.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be used interchangeably throughout the disclosure: “link” and “connection”; “power tone”, “power dither”, and “temporal power variation”; “sub-sensor” and “virtual detector”; and “photodetector array” and “sensor unit”.

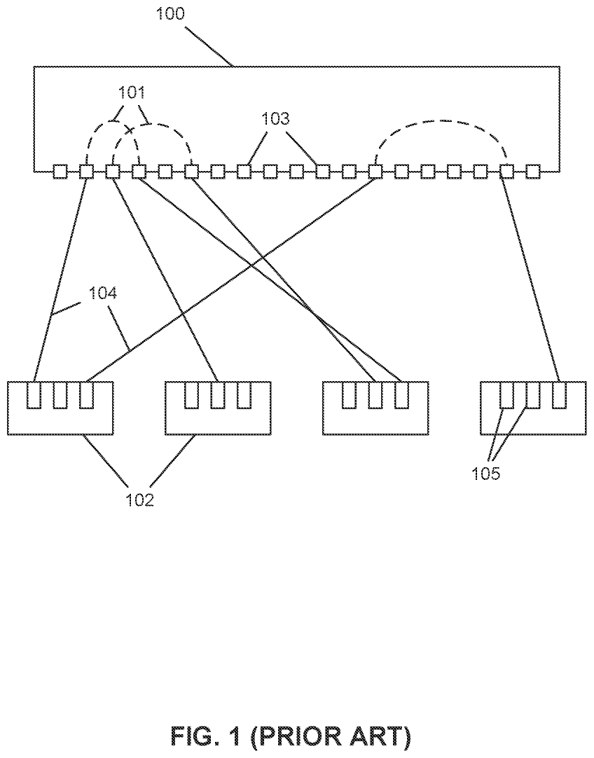

FIG. 1 shows an example, typical of the prior art, of a schematic of an OXC 100 providing connections 101 between network devices 102. The OXC 100 includes a plurality of ports 103, which may be configured to couple with communication channels 104 respective to each of the network devices 102. When coupled with a communication channel 104, each port 103 of the OXC 100 may either receive optical signals from or transmit optical signals to the network device 102 of the respective communication channel 104. Thus, each port 103 may serve as an input port and/or an output port. The connections 101 (or “links”) of the OXC 100 may be configured or reconfigured to connect a particular network device 102 with another particular network device 102. Each network device 102 may have one or more respective optical modules 105 for transmitting and receiving optical signals, and may, for example, be a user equipment. Each communication channel 104 may be an optical communication channel such as a fiber-optic channel. The OXC 100 may be located at a node of a network encompassing each of the network devices 102.

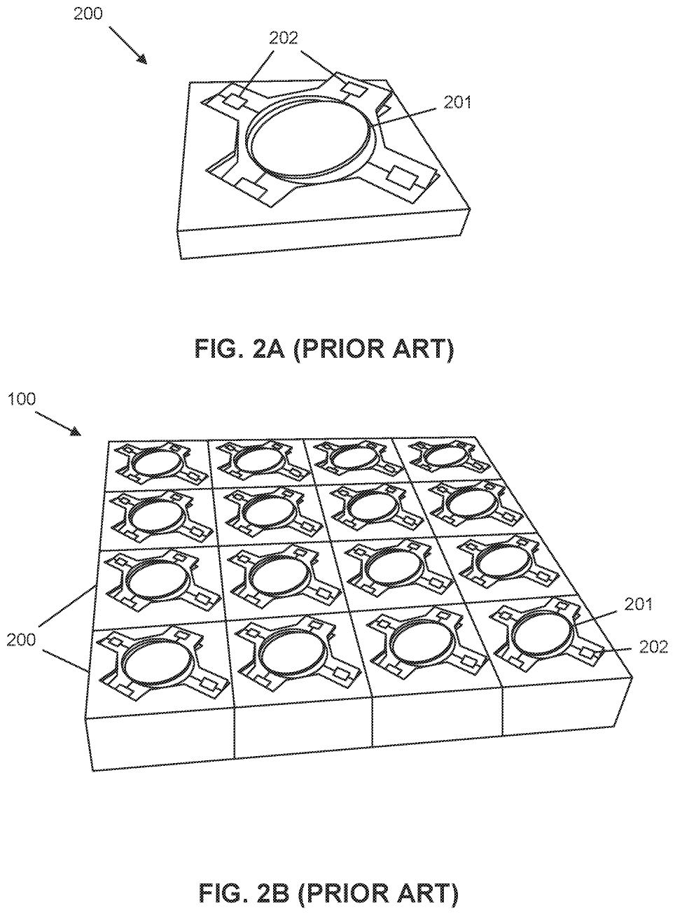

To provide the connections 101 between network devices 102, an OXC 100 may include a plurality of MEMS mirrors. FIG. 2A shows an example, typical of the prior art, of a MEMS mirror 200 that may be used in OXCs 100. The MEMS mirror 200 shown in FIG. 2A is a two-dimensional mirror that may be capable of controllably re-directing an incident optical signal by tilting itself out of a two-dimensional plane. The MEMS mirror 200 includes mirror surface 201 that may be used to re-direct incident optical signals. The MEMS mirror 200 further includes a plurality of MEMS components 202 that may, in response to an electrical signal, such as an applied voltage or current, mechanically and controllably actuate the mirror surface 201. The MEMS mirror 200 may further have one or more dimensions or aspects that are comprised between 1 and 1000 micrometers. FIG. 2B shows an example, typical of the prior art, of a MEMS mirror array 203 comprising a plurality of MEMS mirrors 200. The MEMS mirror array 203 may be configured to receive a plurality of optical signals and direct each of them individually and controllably. One or more MEMS mirror arrays 203 may be used in an OXC 100 to re-direct optical signals received at any port 103 of the OXC 100 to any other port 103 of the OXC 100.

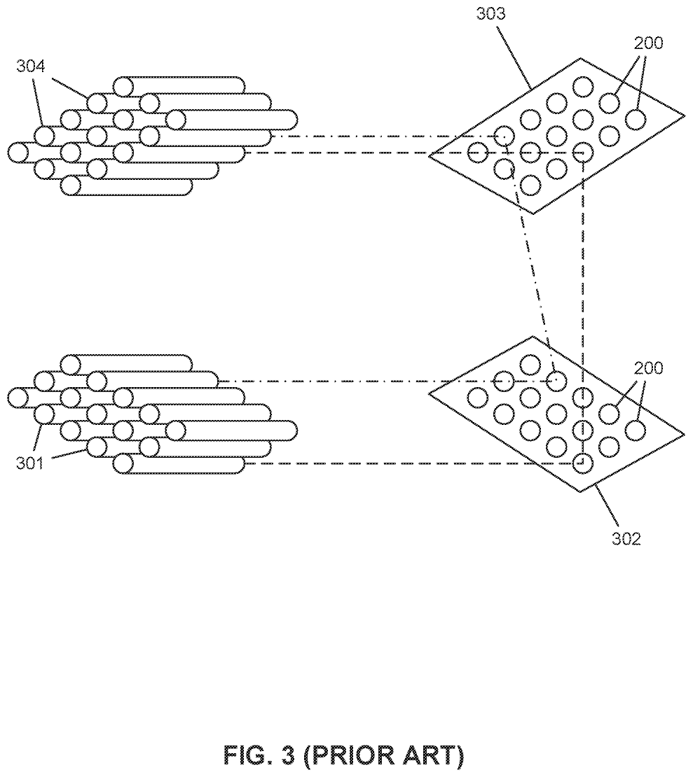

FIG. 3 shows an example, typical of the prior art, of a schematic for redirecting optical signals by two MEMS mirror arrays 203 at an OXC 100. A first set of communication channels 301 are each transmitting optical signals that are received at the OXC 100, such as through a first set of ports (not shown). In FIG. 3, the transmission paths for two optical signals are shown by the lines of dashes and dot-dashes. The optical signals are each received by a respective MEMS mirror 200 of a first of the two MEMS mirror arrays 302. Each MEMS mirror 200 of the first MEMS mirror array 203 may correspond to a respective port of the first set of ports, and therefore to a respective communication channel of the first set of communication channels 301. The optical signals may be redirected by the respective MEMS mirror 200 of the first MEMS mirror array 302 to a respective MEMS mirror 200 of a second of the two MEMS mirror arrays 303. For each optical signal, the respective MEMS mirror 200 of the second MEMS mirror array 303 may correspond to a respective port of a second set of ports of the OXC 100 (not shown), which may in turn correspond to a respective communication channel of a second set of communication channels 304. The optical signals may then be redirected by the respective MEMS mirror 200 of the second MEMS mirror array 303 to the respective communication channel of the second set of communication channels 304. Each MEMS mirror 200 of the first MEMS mirror array 302 may be configured to controllably direct an optical signal to any MEMS mirror 200 of the second MEMS mirror array 303. Similarly, each MEMS mirror 200 of the second MEMS mirror array 303 may be configured to controllably direct an optical signal to any MEMS mirror 200 of the first MEMS mirror array 302. In this way, each communication channel of the first set of communication channels 301 may be connected to each communication channel of the second set of communication channels 304.

Although the MEMS mirror arrays 203 of FIG. 3 may be used to provide the reconfigurable connections 101 of an OXC 100, they may not be able to determine which communication channels 104 should be connected.

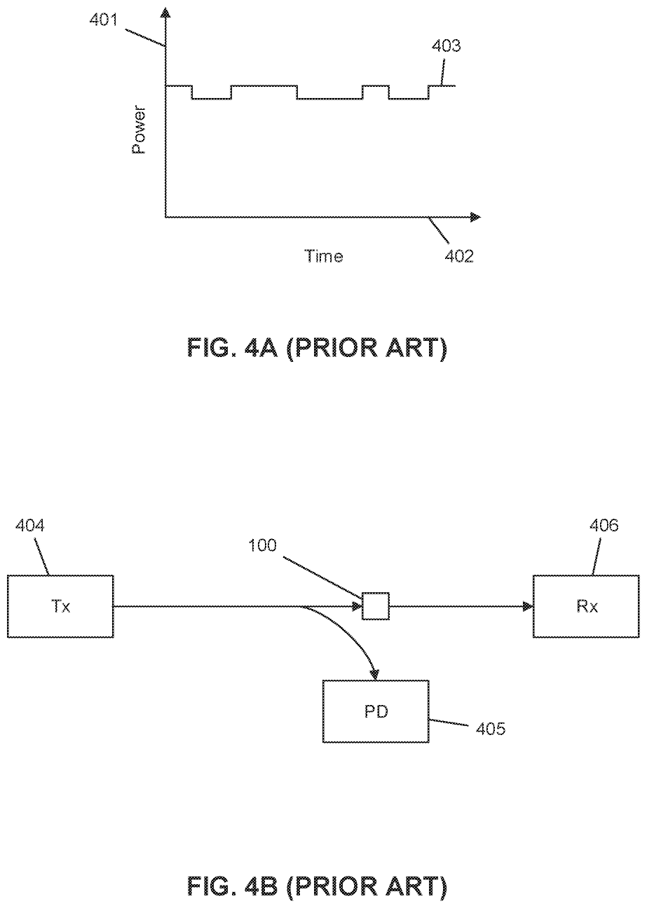

FIG. 4A shows a graph of power 401 versus time 402 for an optical signal with a power dither 403 applied to the optical signal, in a manner typical of the prior art. The power dither 403 is a modulation of the amplitude of the power 401 of the optical signal with time and may be, for example, a PT or another suitable temporal power variation. The power dither 403 may have a frequency comprised between 1 Hz and 1000 MHz for example. The power dither 403 may be used to encode connection information for the specific optical signal and the transmitting communication channel 104.

To access the connection information of the power dither 403, the optical signal may be “tapped” such that a portion of the power of the optical signal is directed away from the transmission path of the optical signal. FIG. 4B shows a schematic, typical of the prior art, for tapping an optical signal. Here, the optical signal is sent from a transmitter (Tx) 404, such as a network device 102, with a power dither 403 that encodes connection information applied to it. The optical signal may be sent through a communication channel such as a fiber-optic channel. At, or approximately near, an OXC 100, the optical signal is tapped to produce a signal sample, which similarly carries the power dither 403. The signal sample may be detected by a photodetector (PD) 405, and the power dither 403 may be monitored by processing circuitry to extract the connection information. The connection information may then be used to provide a connection 101 at the OXC 100 such that the optical signal is then sent to a desired receiver (Rx) 406, such as another network device 102. With the schematic of FIG. 4B, only low-speed (e.g., Hz, kHz), rather than high-speed (e.g., GHz), photodetection may be needed to extract the connection information.

The communication channel of FIG. 4B may be configured to simultaneously transmit a plurality of optical signals, such as in a wavelength division multiplexing system (WDM), by using a respective wavelength to transmit each optical signal. In this case, for each optical signal, a respective power dither 403 having a respective frequency may be applied. The photodetector 405 may then detect an aggregate power measurement from all the optical signals and decompose the aggregate power measurement into contributions from each optical signal in accordance with the respective frequency of each optical signal. The decomposition may, for example, involve a Fourier analysis of the aggregate power measurement. In this way, the connection information of each optical signal may be determined without de-multiplexing the wavelengths of the communication channel.

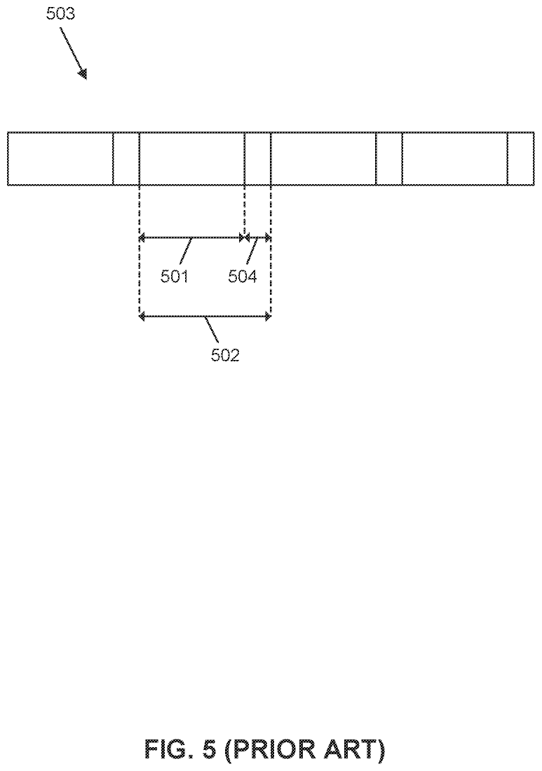

FIG. 5 shows another example, typical of the prior art, of a schematic for providing connection information by an optical signal. Here, the connection information is carried in a payload 501 of a data frame 502 of a series of data frames 503. The series of data frames 503 may form at least part of the optical signal. Each data frame of the series of data frames 503 may be designed for low-speed data transmission (i.e., MHz or lower data rates), such that the connection information is encoded by a power dither 403 using low-speed modulation techniques and extracted using low-speed photodetection, at or approximately near the OXC 100. Each data frame 502 may further comprise an overhead 504, and more than one data frame 502 of the series of data frames may be used to carry the connection information. In the example of FIG. 5, the connection information may comprise 1 to 100 bytes and may be encoded by an appropriate forward error correction method.

In the examples of FIGS. 4A, 4B, and 5, the connection information for each network device 102 is extracted using either a same, single photodetector 405, which is shared among the ports 103 of the OXC 100, or by respective photodetectors for each port 103 of the OXC 100. These photodetection schemes are costly and may require sequential detection that introduces delays, may require precise and complicated optical alignment, and/or may require high-speed photodetection and modulation capabilities.

Embodiments of the present disclosure are generally directed towards providing methods and apparatus for extracting connection information and determining which communication channels 104 should be connected (i.e., link discovery). Embodiments may provide low-cost link discovery at OXCs without a need for complex optical alignment, delays from sequential detection, and high-speed photodetection and modulation capabilities.

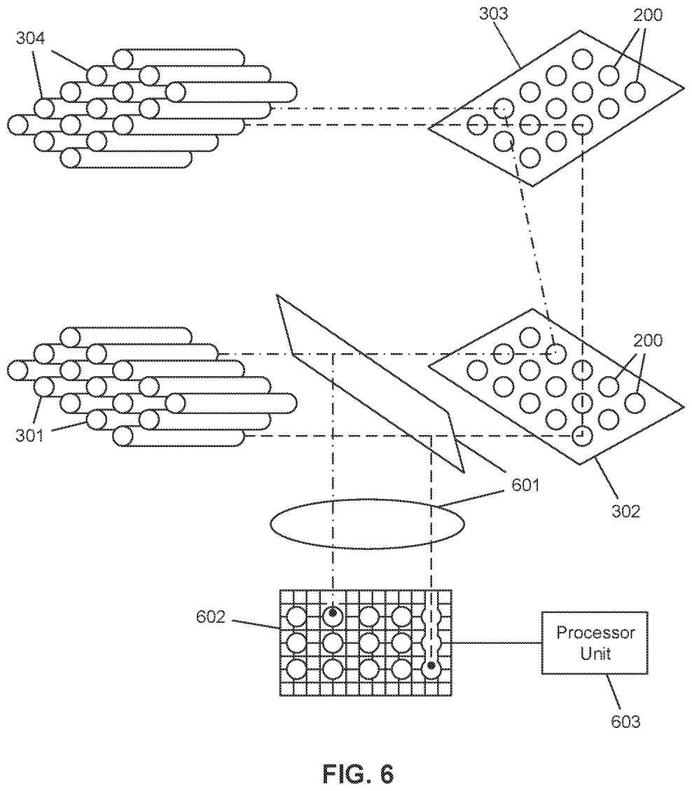

FIG. 6 shows a schematic for link discovery at an OXC 100 in accordance with an embodiment of the present disclosure. The OXC 100 may generally be part of (or form) a node or a switch of a network and be coupled to a plurality of devices encompassed by the network (i.e., network devices 102). A first set of communication channels 301 may each be transmitting optical signals that are received at the OXC 100. Examples of transmission paths for two optical signals are shown by the lines of dashes and dot-dashes in FIG. 6. Each optical signal may have a respective power dither 403, or more generally, a respective temporal power variation, associated with it that encodes respective connection information in that optical signal. The respective temporal power variation may have been applied to each optical signal by a suitable optical modulation technique. Each communication channel of the first set of communication channels 301 may correspond to a respective device of a plurality of devices. Each communication channel of the first set of communication channels 301 may be an optical communication channel, such as a fiber-optic channel. Each device of the plurality of devices may, for example, be a user equipment, which may have an optical module 105 for transmitting and receiving optical signals. The respective communication channel of each optical signal may define a desired connection between one communication channel of a first set of communication channels 301 and one communication channel of a second set of communication channels 304.

Each optical signal received at the OXC 100 may be directed toward a same sensor unit 602, by one or more optical components 601 associated with or belonging to the OXC 100. The one or more optical components 601 may be free-space optical components and may include one or more taps configured to form a respective signal sample from a respective portion of each optical signal. Each of the taps may be said to tap the respective optical signal. Each signal sample may carry, or inherit, the temporal power variation of the respective optical signal. In some embodiments, each port of the OXC 100 may have associated with it a respective tap. Each tap may include, for example, an optical beamsplitter. The one or more optical components 601 may further include optical components, such as lenses and collection optics, configured to direct a respective remaining portion of each optical signal to a first MEMS mirror array 302 and to direct each signal sample to the same sensor unit 602. In an embodiment, the one or more optical components 601 may include a beamsplitter that splits all the signals stemming from the optical channels 301 and directs the split signals toward the sensor unit 602. In some embodiments, the one or more optical components 601 may include a beamsplitter to split the optical signals and a lens that images the split signals on the sensor unit 602.

The same sensor unit 602 may be configured to receive the respective signal sample of each optical signal. The signal samples may be directed to the same sensor unit 602 by the one or more optical components 601 to produce a spatiotemporal power distribution at the same sensor unit 602. Each signal sample may be spatially resolved or spatially encoded in the spatiotemporal power distribution. Thus, each signal sample may provide a respective spatial contribution to the spatiotemporal power distribution. For example, different spatial portions of the spatiotemporal power distribution may depend from different signal samples. The spatiotemporal power distribution may further depend from the respective temporal power variation of each signal sample. For example, each spatial portion of the spatiotemporal power distribution may temporally vary in accordance with the temporal power variation of the signal samples contributing to that spatial portion. In some embodiments, the same sensor unit 602 may be a two-dimensional array of photodetector pixels, as described hereinbelow.

The same sensor unit 602 may detect the spatiotemporal power distribution by imaging the signal samples to accordingly produce one or more electrical signals that may be analyzed by a processor unit 603 coupled to the same sensor unit 602. The processor unit 603 may be configured to decode the spatiotemporal power distribution to obtain the respective connection information encoded in each optical signal.

The connection information respective to each optical signal may be used to configure one or more optical connections at the OXC 100. This may include configuring the MEMS mirrors 200 of the first MEMS mirror array 203 to redirect one or more optical signals in accordance with their respective connection information. Each MEMS mirror 200 of the first MEMS mirror array 203 may correspond to a respective port of a first set of ports (not shown), which may receive the optical signals at the OXC 100 and may correspond to a respective communication channel of the first set of communication channels 301. The first set of ports may be located along the transmission path of the optical signals before or after the one or more optical components 601. The one or more optical signals may be redirected by the respective MEMS mirror 200 of the first MEMS mirror array 302 to a respective MEMS mirror 200 of a second MEMS mirror array 303. For each optical signal, the respective MEMS mirror 200 of the second MEMS mirror array 303 may correspond to a respective port of a second set of ports of the OXC 100 (not shown), which may in turn correspond to a respective communication channel of the second set of communication channels 304. The one or more optical signals may then be redirected, in accordance with the connection information, by the respective MEMS mirror 200 of the second MEMS mirror array 303 to the respective communication channel of the second set of communication channels 304. Each MEMS mirror 200 of the first MEMS mirror array 302 may be configured to controllably direct an optical signal to any MEMS mirror 200 of the second MEMS mirror array 303. Similarly, each MEMS mirror 200 of the second MEMS mirror array 303 may be configured to controllably direct an optical signal to any MEMS mirror 200 of the first MEMS mirror array 302. In this way, each communication channel of the first set of communication channels 301 may be connected to a respective communication channel of the second set of communication channels 304, as defined by the connection information.

In some embodiments, each port of the OXC 100 may be configured to receive optical signals at the OXC 100 and transmit optical signals from the OXC 100. In other words, each port of the OXC 100 may be bidirectional. In these embodiments, each port of the OXC 100 may be configured to be connected with each other port of the OXC 100. In some embodiments, a first set of ports of a plurality of ports of an OXC 100 may correspond to those ports of the plurality of ports that are receiving optical signals, and a second set of ports of the plurality of ports of the OXC 100 may correspond to those ports of the plurality of ports that are transmitting optical signals. In these embodiments, the first set of ports and the second set of ports may change based on whether they are receiving or transmitting optical signals.

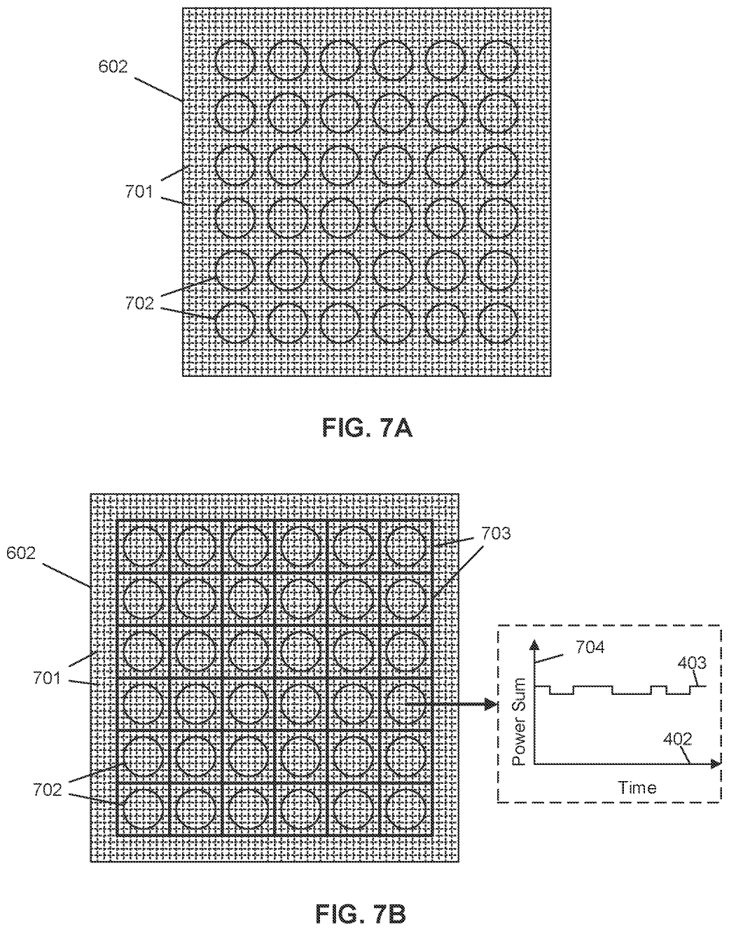

FIG. 7A shows an example of a sensor unit 602 in accordance with an embodiment of the present disclosure. The sensor unit 602 may comprise a plurality of pixels 701 (shown by dashed lines), which may, for example, be arranged in a two-dimensional array. Each pixel 701 may be a photodetector, such as a photodiode or a phototransistor. Each pixel may have a frame rate that is sufficient for detecting the temporal power variations of signal samples. For example, the frame rate of each pixel may be 100 Hz for temporal power variations applied with a modulation rate of 50 Hz. In FIG. 7, a six-by-six grid of intersections 702 between respective light beams associated with each of 36 signal samples and the sensor unit 602 are shown (circles). In other embodiments, different amounts of light beams may intersect with the sensor unit 602 and the intersections 702 may be of a different spatial pattern. The respective light beam for each signal sample may be formed by the one or more optical components at an OXC 100, as described in relation to FIG. 6. In other embodiments, the light beams may be of other shapes and have a respective power distribution, such as a Gaussian distribution. Each light beam may span a respective set of pixels 701 of the plurality of pixels 701. The respective set of pixels 701 of each light beam may overlap with the respective set of pixels 701 of one or more other light beams. The intersections 702 of the light beams of the signal samples with the sensor unit 602 may form a spatiotemporal power distribution that temporally varies according to the temporal power variations of the signal samples. The sensor unit 602 may be sufficiently large for all the light beams of the signal samples to form complete intersections with the sensor unit 602.

To decode the spatiotemporal power distribution of FIG. 7A, the respective contributions from each of the light beams of the signal samples may be identified and delineated. A processor unit 603, as described in relation to FIG. 6, may receive from each pixel 701 of the sensor unit 602 a respective electrical signal, such as a current or voltage, that is in proportion to the power received by that pixel according to the spatiotemporal power distribution. The processor unit 603 may analyze the electrical signals to partition the sensor unit 602 into a plurality of virtual detectors (i.e., sub-sensors), with each virtual detector corresponding to a respective signal sample. Each virtual detector may encompass the respective set of pixels 701 of a respective intersection 702 of a light beam. The processor unit 603 may integrate, for each virtual detector, the respective portion of the spatiotemporal power distribution to obtain a respective power sum.

FIG. 7B shows an example of a partitioning of the pixels 701 of the sensor unit 602 of FIG. 7A into a plurality of virtual detectors 703, in accordance with an embodiment of the present disclosure. With 36 light beams forming intersections 702, the pixels 701 of the sensor unit 602 are partitioned into 36 virtual detectors 703.

Further to decoding the spatiotemporal power distribution, the respective power sum obtained for each virtual detector 703, according to the spatiotemporal power distribution, may be monitored over time for a pre-determined duration or by data frame to obtain the respective connection information of the signal sample corresponding to that virtual detector 703. This may include summing, for each virtual detector 703, power contributions from all the pixels 701 of that virtual detector 703. An example of power sum 704 versus time 402 for a virtual detector 703 is shown in a graph in FIG. 7B.

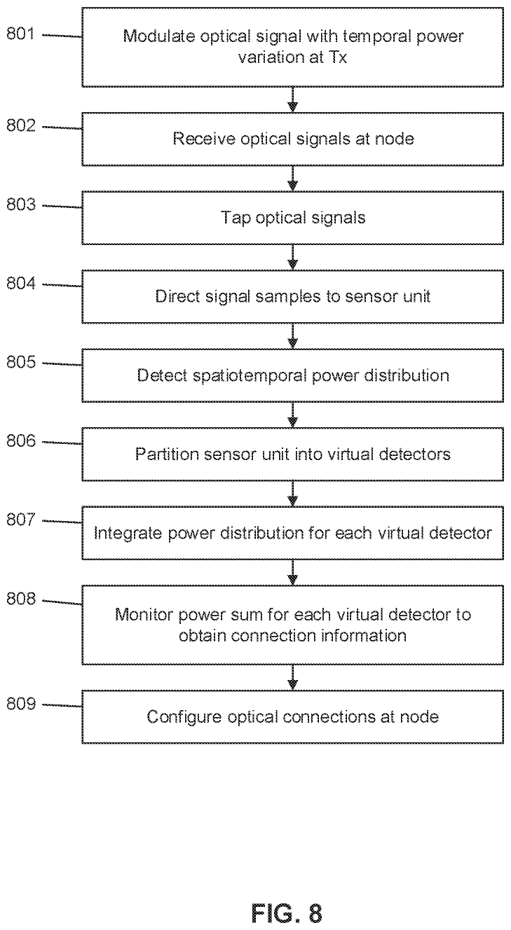

FIG. 8 shows a flowchart of a method for link discovery in accordance with an embodiment of the present disclosure. At action 801, one or more transmitters 404 may modulate a respective optical signal with a respective temporal power variation, such as a power dither 403 or PT. Each temporal power variation may encode respective connection information for the respective transmitter 404. Each transmitter 404 may be a respective device among a plurality of devices encompassed in a network. At action 802, each optical signal may be received at a node of the network, which may include an OXC 100. The node may have a first set of ports, by which the optical signals may be received, and a second set of ports, by which the optical signals are transmitted onwards from the node. At action 803, at the node, each optical signal may be tapped, such as by one or more optical components 601, to obtain a respective signal sample. Each signal sample may inherit the respective temporal power variation of the respective optical signal. At action 804, at the node, each signal sample may be directed, such as by the one or more optical components 601, to a same sensor unit 602, such as a photodetector array. At action 805, at the node, a spatiotemporal power distribution may be detected from each signal sample by the same sensor unit. This may include detecting, for each signal sample, a respective intersection 702 of a respective light beam with a respective set of pixels of the same sensor unit 602. The spatiotemporal power distribution may further depend from the respective temporal power variation of each signal sample. At action 806, at the node, the same sensor unit 602 may be partitioned, by a processing unit 603, into a plurality of virtual detectors 703, in accordance with the spatiotemporal power distribution. At action 807, at the node, a respective power sum may be obtained, by the processing unit 603, for each virtual detector 703 by integrating the respective portion of the spatiotemporal power distribution for the respective virtual detector 703. At action 808, at the node, the respective power sum of each virtual detector 703 may be monitored to obtain the connection information respective to the signal sample of that virtual detector. Actions 806 to 808 may constitute decoding of the spatiotemporal power distribution. At action 809, one or more optical connections 101 at the node may be configured to couple each port of the first set of ports to a respective port of the second set of ports in accordance with the connection information of the respective optical signal received. This may include configuring one or more MEMS mirrors 200 of a plurality of MEMS mirror arrays 302.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

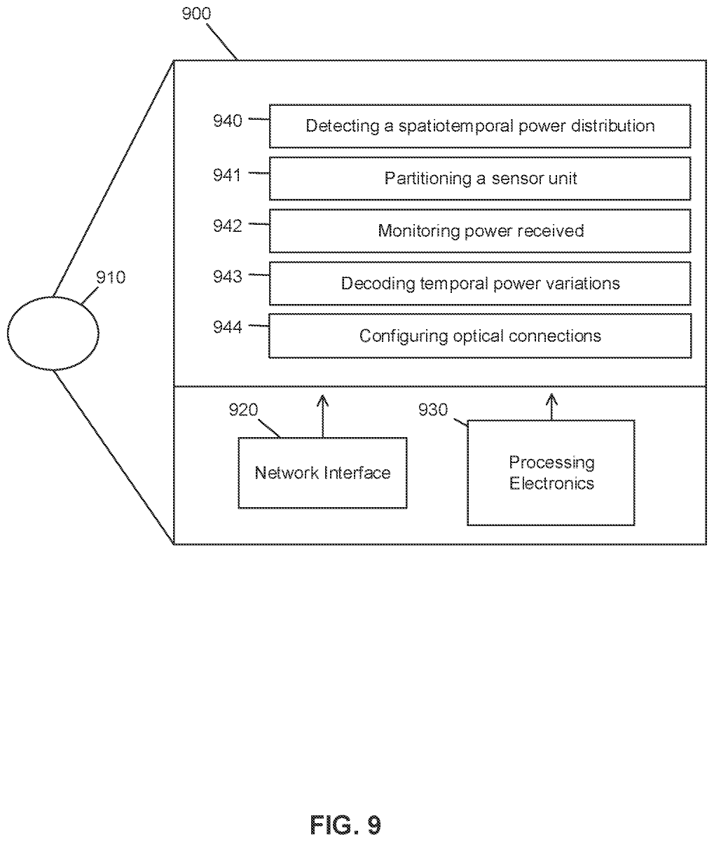

FIG. 9 shows an apparatus 900 for link discovery, according to embodiments of the present disclosure. The apparatus 900 may, for example, be an OXC 100 configured according to embodiments of the present disclosure. The apparatus 900 may be located at a node 910 of the network. The apparatus may include a network interface 920 and processing electronics 930. The processing electronics 930 may include a computer processor executing program instructions stored in memory, or other electronics components such as digital circuitry, including for example FPGAs and ASICs. The processing electronics 930 may be configured as a processing unit 603 of an OXC 100. The network interface 920 may include an optical communication interface or radio communication interface, such as a transmitter and receiver. The apparatus may include several functional components, each of which may be partially or fully implemented using the underlying network interface 920 and processing electronics 930. Examples of functional components may include modules for detecting 940 a spatiotemporal power distribution, partitioning 941 a sensor unit, monitoring 942 power received, decoding 943 temporal power variations, and configuring 944 optical connections.

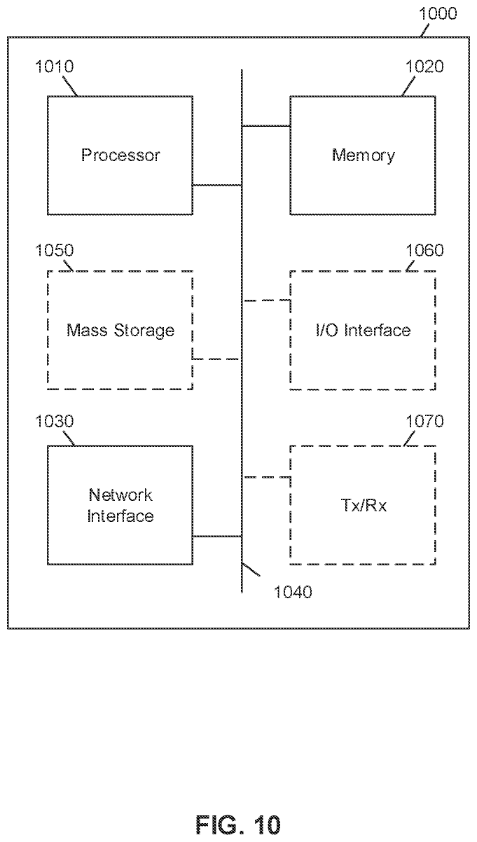

FIG. 10 shows a schematic diagram of an electronic device 1000 that may perform any or all of the operations of the above methods and features explicitly or implicitly described herein, according to different embodiments of the present disclosure. For example, a computer equipped with network function may be configured as electronic device 1000. The electronic device 1000 may be used to implement the apparatus 900 of FIG. 9, for example. The electronic device 1000 may further be used as part of an OXC 100 according to embodiments of the present disclosure, such as part of a processing unit 603, for example.

As shown, the electronic device 1000 may include a processor 1010, such as a Central Processing Unit (CPU) or specialized processors such as a Graphics Processing Unit (GPU) or other such processor unit, memory 1020, network interface 1030, and a bi-directional bus 1040 to communicatively couple the components of electronic device 1000. Electronic device 1000 may also optionally include non-transitory mass storage 1050, an I/O interface 1060, and a transceiver 1070. According to certain embodiments, any or all of the depicted elements may be utilized, or only a subset of the elements. Further, the electronic device 1000 may contain multiple instances of certain elements, such as multiple processors, memories, or transceivers. Also, elements of the hardware device may be directly coupled to other elements without the bi-directional bus 1040. Additionally or alternatively to a processor and memory, other electronics, such as integrated circuits, may be employed for performing the required logical operations.

The memory 1020 may include any type of tangible, non-transitory memory such as static random access memory (SRAM), dynamic random access memory (DRAM), synchronous DRAM (SDRAM), read-only memory (ROM), any combination of such, or the like. The mass storage element 1050 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1050 may have recorded thereon statements and instructions executable by the processor 1010 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for managing optical connections in a network, at a node of the network, the node having a first set of ports and a second set of ports, the method comprising:
receiving, at each port of the first set of ports, a respective optical signal encoded with respective connection information defined by a respective temporal power variation of the respective optical signal, the respective connection information, for each optical signal, identifying which port of the second set of ports is to be connected to the respective port of the first set of ports;
tapping each optical signal to obtain a respective signal sample having the respective power variation of the respective optical signal;
imaging, by a same sensor unit, the signal samples to obtain a spatiotemporal power distribution depending from the respective temporal power variation of each optical signal, each of the signal samples providing a respective spatial contribution to the spatiotemporal power distribution;
decoding the spatiotemporal power distribution to obtain the respective connection information encoded in each optical signal; and
configuring one or more optical connections to couple each port of the first set of ports to a respective port of the second set of ports in accordance with the respective connection information.

2. The method of claim 1 wherein decoding the spatiotemporal power distribution to obtain the respective connection information encoded in each optical signal includes:
partitioning, in accordance with the spatiotemporal power distribution, the same sensor unit into a plurality of sub-sensors each corresponding to one port of the first set of ports; and
integrating, for each sub-sensor of the plurality of sub-sensors, a respective portion of the spatiotemporal power distribution to obtain a respective power sum.

3. The method of claim 2 wherein decoding the spatiotemporal power distribution to obtain the respective connection information encoded in each optical signal further includes:
monitoring, for each sub-sensor of the plurality of sub-sensors, the respective power sum for a pre-determined duration.

4. The method of claim 3 wherein the pre-determined duration corresponds to a data frame of each optical signal.

5. The method of claim 1 wherein, for each optical signal, the respective temporal power variation is a respective amplitude modulation pilot tone.

6. The method of claim 1 wherein the same sensor unit is a two-dimensional array of photodetector pixels.

7. The method of claim 1 wherein configuring the one or more optical connections to couple each port of the first set of ports to the respective port of the second set of ports in accordance with the respective connection information includes configuring a plurality of mirror arrays, each mirror array including a plurality of microelectromechanical mirrors.

8. The method of claim 7 wherein:
for one mirror array of the plurality of mirror arrays, each microelectromechanical mirror corresponds to a respective port of the first set of ports,
and
for one other mirror array of the plurality of mirror arrays, each microelectromechanical mirror corresponds to a respective port of the second set of ports.

9. The method of claim 1 further comprising:
directing each signal sample to the same sensor unit by one or more optical components.

10. A network switch comprising:
a plurality of ports each configured to receive a respective optical signal, each optical signal encoded with respective connection information defined by a respective temporal power variation of the respective optical signal, the respective connection information, for each optical signal, identifying a respective other port of the plurality of ports to be connected to the port receiving the respective optical signal, each port having a respective tap configured to obtain a respective signal sample from the respective optical signal, each signal sample having the temporal power variation of the respective optical signal;
a sensor unit configured to image the signal samples to obtain a spatiotemporal power distribution depending from the respective temporal power variation of each optical signal, each of the signal samples providing a respective spatial contribution to the spatiotemporal power distribution;
and
a processor unit configured to decode the spatiotemporal power distribution to obtain, for each port, the respective connection information encoded in each optical signal.

11. The network switch of claim 10 further comprising:
a linker component configured to connect each port of the plurality of ports with every other port of the plurality of ports.

12. The network switch of claim 11 wherein the processor unit is further configured to direct the linker component to connect each of one or more ports of the plurality of ports to the respective other port of the plurality of ports in accordance with the respective connection information encoded in the respective optical signal.

13. The network switch of claim 10 wherein the processor unit being configured to decode the spatiotemporal power distribution to obtain, for each port, the respective connection information encoded in each optical signal includes being configured to:
partition, in accordance with the spatiotemporal power distribution, the sensor unit into a plurality of sub-sensors each corresponding to one port of the plurality of ports;
and
integrate, for each sub-sensor of the plurality of sub-sensors, a respective portion of the spatiotemporal power distribution to obtain a respective power sum.

14. The network switch of claim 13 wherein the processor unit being configured to decode the spatiotemporal power distribution to obtain, for each port, the respective connection information encoded in each optical signal further includes being configured to:
monitor, for each sub-sensor of the plurality of sub-sensors, the respective power sum for a pre-determined duration.

15. The network switch of claim 14 wherein the pre-determined duration corresponds to a data frame of each optical signal.

16. The network switch of claim 10 further comprising:
one or more optical components configured to direct each signal sample to the sensor unit.

17. The network switch of claim 10 wherein the sensor unit is a two-dimensional array of photodetector pixels.

18. The network switch of claim 10 wherein, for each optical signal, the respective temporal power variation is a respective amplitude modulation pilot tone.

19. The network switch of claim 10 further comprising a plurality of mirror arrays each configured connect a respective set of ports from among the plurality of ports to another set of ports from among the plurality of ports, each mirror array including a plurality of microelectromechanical mirrors.

20. The network switch of claim 11 wherein the linker component includes a plurality of microelectromechanical mirrors each corresponding to a respective port of the plurality of ports.
